(19) United States
(12) Patent Application Publication
(10) Pub. No.: US 2025/0383452 A1
(43) Pub. Date: Dec. 18, 2025

(54) GNSS RAY TRACING TECHNIQUES

(71) Applicant: Apple Inc., Cupertino, CA (US)

(72) Inventors: Mark G. Petovello, Santa Cruz, CA (US); Isaac T. Miller, Half Moon Bay, CA (US); Glenn D. MacGougan, San Jose, CA (US); Chaochao Wang, Placentia, CA (US); Daochun Liu, San Diego, CA (US); Harsha Shirahatti, Santa Clara, CA (US); Joe Khalife, Redwood City, CA (US); Kevin Chin, Palo Alto, CA (US); Lalitaprasad V. Daita, Fremont, CA (US)

(73) Assignee: Apple Inc., Cupertino, CA (US)

(21) Appl. No.: 19/236,753

(22) Filed: Jun. 12, 2025

Related U.S. Application Data
(60) Provisional application No. 63/659,784, filed on Jun. 13, 2024.

(51) Int. Cl. G01S 19/22; G01S 19/24; G01S 19/35

(52) U.S. Cl. CPC G01S 19/22; G01S 19/24; G01S 19/35

(57) ABSTRACT

Techniques may include receiving signal measurements of one ranging signal that is transmitted by a first satellite of a global navigation satellite system, where the one ranging signal is measured by the device's antennas, each measurement corresponding to a different path to the antennas of the mobile device. In addition, the techniques may include identifying a path delay for each signal measurement. Techniques may include simulating, for different locations, possible paths between the mobile device and the first satellite, where the possible paths include at least one path that reflects from a building in a map model around a previously measured location of the mobile device; determining an estimated path delay for each simulated path; comparing the path delay for each signal measurement to each estimated path delay to identify at least one matching simulated path for each signal measurement; and determining a location of the mobile device.

### CROSS-REFERENCES TO OTHER APPLICATIONS

This application claims priority to U.S. Provisional Application No. 63/659,784, for “GNSS RAY TRACING TECHNIQUES” filed on Jun. 13, 2024, which is herein incorporated by reference in its entirety for all purposes.

### BACKGROUND

Global navigation satellite system (GNSS) systems may assume that there is a straight-line-of-sight path from each GNSS satellite and a receiver. In a line-of-sight GNSS system, the receiver's position is determined by calculating distances along the straight-line paths and using these distances to triangulate the receiver's position relative to the satellites. Line-of-sight use cases may produce accurate location determinations if nothing obstructs the path between the receiver and the satellite (e.g., the time-of-flight corresponds to a direct distance between the satellite and receiver). Some environments may not be suitable for line-of-sight location determination.

### SUMMARY

Ray tracing may enable a mobile device to make accurate location determinations in locations where line-of-sight methods of processing GNSS measurements may not be accurate. For example, tall buildings in a city's business district may prevent satellite signals from reaching the device's receiver along a direct path. The mobile device can enable non-line-of-sight GNSS location determinations with simulated signal paths. The mobile device can generate the simulated signal paths by projecting rays at different angles and at a number of different locations. The mobile device may use a building model to determine non line of sight paths between the device and GNSS satellites. The non-line-of sight signal paths can be determined by comparing the simulated signal's flight time against the measured flight times for the received signals.

The mobile device can measure received signals using GNSS channels. A channel can be the hardware and software in a GNSS receiver, and the mobile device may identify a received signal by comparing local copies of a signal against the received signal. The mobile device may vary the frequency and phase offset between local copies, and a similarity between the received signal and copies may be used to identify the received signal's properties. In some embodiments, one channel may be allocated to each GNSS satellite, or multiple channels may be allocated to each GNSS satellite.

The techniques may include receiving a plurality of signal measurements of one ranging signal that is transmitted by a first satellite of a global navigation satellite system, where the one ranging signal is measured by one or more antennas of the mobile device, each measurement corresponding to a different path of the one ranging signal to the one or more antennas of the mobile device. Techniques may also include identifying a path delay for each signal measurement of the plurality of signal measurements of the one ranging signal. Techniques may furthermore include simulating, for each of a plurality of locations, a set of possible paths between the mobile device and the first satellite, where the set of possible paths include at least one path that reflects from a building in a map model around a previously measured location of the mobile device, thereby determining a plurality of sets of simulated paths; determining an estimated path delay for each simulated path; comparing the path delay for each signal measurement of the plurality of signal measurements to each estimated path delay to identify at least one matching simulated path for each signal measurement; and determining a location of the mobile device based on the matching simulated path for each signal measurement. Other embodiments of these techniques include corresponding methods, computer systems, apparatus, and computer programs recorded on one or more non-transitory computer storage devices, each configured to perform the actions of the techniques.

A better understanding of the nature and advantages of embodiments of the present disclosure may be gained with reference to the following detailed description and the accompanying drawings.

### BRIEF DESCRIPTION OF THE DRAWINGS

FIG. 1 is a schematic diagram of a communication system according to various embodiments.

FIG. 2 is a block diagram of the user equipment according to various embodiments.

FIG. 3 is a functional diagram of the user equipment according to various embodiments.

FIGS. 4A-4B show simplified diagrams of non-line of sight Global Navigation Satellite System (GNSS) location determinations according to various embodiments.

FIG. 5 is a simplified diagram showing ray tracing for a global navigation satellite system (GNSS) according to various embodiments.

FIG. 6 shows a block diagram of a ray tracing for GNSS algorithm according to various embodiments.

FIG. 7 is a simplified diagram showing multiple measurements for a signal from a satellite according to various embodiments.

FIG. 8 is a simplified graph of the output of an ambiguity function according to various embodiments.

FIG. 9 shows a simplified block diagram of a one-to-one channel architecture according to various embodiments.

FIG. 10 shows a simplified diagram of a one-to-many channel architecture 1000 according to various embodiments.

FIG. 11 is a simplified diagram of an architecture for GNSS navigation according to various embodiments.

FIG. 12 is a flowchart illustrating a method for identifying exit events according to various embodiments.

FIG. 13 is a block diagram of an example electronic device according to at least one embodiment.

### DETAILED DESCRIPTION

Global Navigation Satellite System (GNSS) receivers compute their location by making pseudorange measurements (and/or range rate measurements) with satellites, and using these measurements to compute the location of the receiver relative to the satellite locations. Measurement (e.g., pseudorange measurement) generation can be performed by the receiver's measurement engine (ME), which can generate a local simulated version of the incoming signal, correlate that local simulated signal with the incoming signal, and then adjust the local simulated signal to mirror the incoming signal. This signal tracking logic can be applied to the part of the signal corresponding to the shortest path between the satellite and receiver, e.g., a line-of-sight (LOS) path.

However, in areas where there are multiple reflecting surfaces surrounding the receiver, such as dense urban areas like downtown New York or Hong Kong, satellite signals can be received along multiple paths. These different paths can sometimes be distinguished within the ME at which point the ME tries to isolate the shortest path. A position engine (PE) can be responsible for ingesting measurements from the ME, along with any other assistance data/measurements that may be available, and can use the measurements to compute the receiver's position. As an example, the computation of the receiver's position can be performed using an estimator, e.g., a statistical estimator such as a Kalman Filter.

The position engine and measurement engine can be part of the location manager examples of which are described in more detail below. The estimator may predict the measurements from the ME based on knowledge of satellite position and the current estimates of receiver position. As noted above, GNSS receivers aim to track the portion of the signal that corresponds to the LOS path. This can be because, in the absence of additional information, the PE's estimator may predict the measurement assuming a LOS path.

In areas with many signal reflections, instead of producing a single measurement corresponding to the shortest signal path, the ME can report measurements for all distinguishable paths. In other words, the ME can produce one or more measurements for each satellite. By extension, the PE may use building models (i.e., models of buildings in the vicinity) in combination with ray tracing techniques to compute the possible paths by which a signal could traverse from a satellite to the receiver. A building model can include information about the shape or size of the building. For example, the building model may include a height, a width, and a depth for a particular building.

By predicting one or more measurements (e.g., pseudorange measurements) for each satellite, the PE's estimator can then ingest all of the measurements provided by the ME for a given satellite. Compared to the case where the ME produces a single measurement per satellite, the use of multiple measurements in combination with ray tracing can improve the geometrical strength of the position solution. Additional measurements can also facilitate the GNSS ray tracing algorithm by providing additional information to help distinguish different paths and position receiver locations.

### I. Example Systems for Determining Location

A mobile device can communicate with satellites of a global navigation satellite system (GNSS) to determine the device's location. GNSS navigation may begin with a signal acquisition stage where the mobile device establishes communication with available GNSS satellites. Once the satellites are acquired, the mobile device can use received ranging messages from these satellites to determine the device's location.

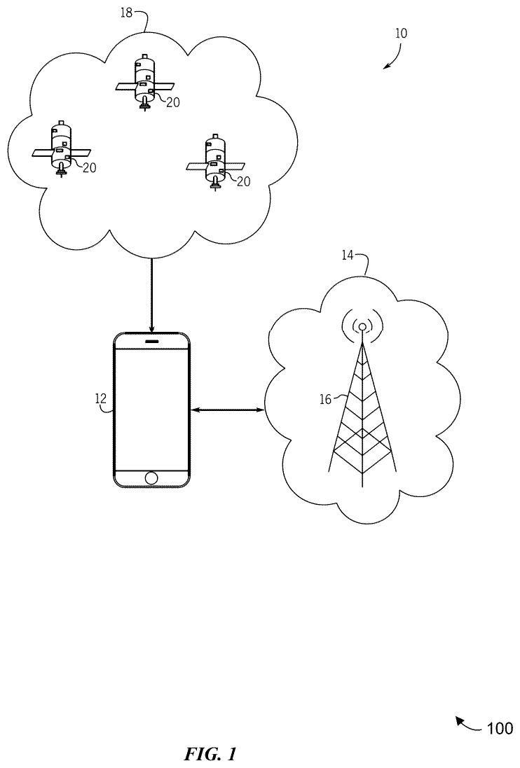

FIG. 1 is a schematic diagram of a communication system 10 having user equipment 12 communicatively coupled to a cellular network 11 (e.g., a third generation (3G) cellular network, a fourth generation (4G) or Long Term Evolution (LTE) cellular network, a fifth generation (5G) or New Radio (NR) cellular network, a beyond 5G cellular network, or the like) via a cellular base station 12 (e.g., a NodeB, an eNodeB, a gNodeB, or the like), and communicatively coupled to a GNSS network 18 via one or more GNSS satellites 20, accordingly to embodiments of the present disclosure. The cellular network 11 may be implemented and/or supported by multiple such base stations 12, radio access networks, core networks, and so on. Similarly, the GNSS network 18 may be implemented and/or supported by multiple such GNSS satellites 20, ground stations, and so on. Although certain embodiments are described herein with respect to processing a GNSS signal from one or more GNSS satellites 20, it should be understood that in other embodiments, the user equipment 12 may be communicatively coupled to a GPS network in addition to, or instead of, the GNSS network 18 via one or more GPS satellites and process a GPS signal from the GPS satellites in accordance with embodiments described herein.

The user equipment 12 may receive signals from the GNSS satellites 20 and process the signals to determine a global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12. In certain embodiments, the user equipment 12 may generate and maintain respective tracking loops for each pilot channel received from the GNSS satellites 20. For instance, the user equipment 12 may receive a single pilot channel from a GNSS satellite 20, two pilot channels from a GNSS satellite 20, three pilot channels from a GNSS satellite 20, four pilot channels from a GNSS satellite 20, five pilot channels or more from a GNSS satellite 20, and so on. Additionally, the user equipment 12 may receive pilot channels from more than one GNSS satellite 20 (e.g., up to thirty-five or more satellites).

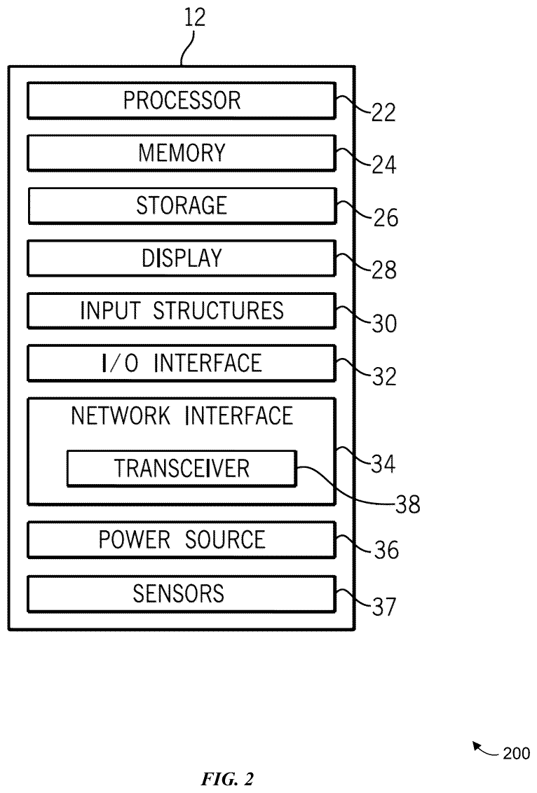

FIG. 2 is a block diagram of the user equipment 12 (e.g., an electronic device) of FIG. 1, according to embodiments of the present disclosure. The user equipment 12 may include, among other things, one or more processors 22 (collectively referred to herein as a single processor for convenience, which may be implemented in any suitable form of processing circuitry), memory 24, nonvolatile storage 26, a display 28, input structures 30, an Input/Output (I/O) interface 32, a network interface 34, a power source 36, and one or more sensors 37. The various functional blocks shown in FIG. 2 may include hardware elements (including circuitry), software elements (including machine-executable instructions) or a combination of both hardware and software elements (which may be referred to as logic). The processor 22, the memory 24, the nonvolatile storage 26, the display 28, the input structures 30, the I/O interface 32, the network interface 34, the power source 36, and/or the sensors 37 may each be communicatively coupled directly or indirectly (e.g., through or via another component, a communication bus, a network) to one another to transmit and/or receive data between one another. It should be noted that FIG. 2 is merely one example of a particular implementation and is intended to illustrate the types of components that may be present in the user equipment 12.

By way of example, the user equipment 12 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple, Inc. of Cupertino, California), a wearable electronic device (e.g., in the form of an Apple Watch® by Apple Inc. of Cupertino, California), and other similar devices. It should be noted that the processor 22 and other related items in FIG. 2 may be generally referred to herein as “data processing circuitry.” Such data processing circuitry may be embodied wholly or in part as software, hardware, or both. Furthermore, the processor 22 and other related items in FIG. 2 may be a single contained processing module or may be incorporated wholly or partially within any of the other elements within the user equipment 12. The processor 22 may be implemented with any combination of general purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processor 22 may include one or more application processors, one or more baseband processors, one or more auxiliary processors, or any combination thereof, and perform the various functions described herein.

In the user equipment 12 of FIG. 2, the processor 22 may be operably coupled with a memory 24 and a nonvolatile storage 26 to perform various algorithms. Such programs or instructions executed by the processor 22 may be stored in any suitable article of manufacture that includes one or more tangible, computer-readable media. The tangible, computer-readable media may include the memory 24 and/or the nonvolatile storage 26, individually or collectively, to store the instructions or routines. The memory 24 and the nonvolatile storage 26 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 22 to enable the user equipment 12 to provide various functionalities.

In certain embodiments, the display 28 may facilitate users to view images generated on the user equipment 12. In some embodiments, the display 28 may include a touch screen, which may facilitate user interaction with a user interface of the user equipment 12. Furthermore, it should be appreciated that, in some embodiments, the display 28 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 30 of the user equipment 12 may enable a user to interact with the user equipment 12 (e.g., pressing a button to increase or decrease a volume level). The I/O interface 32 may enable user equipment 12 to interface with various other electronic devices, as may the network interface 34. In some embodiments, the I/O interface 32 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 34 may include, for example, one or more interfaces for a personal area network (PAN), such as an ultra-wideband (UWB) or a BLUETOOTH® network, for a local area network (LAN) or wireless local area network (WLAN), such as a network employing one of the IEEE 902.11x family of protocols (e.g., WI-FI®), and/or a wide area network (WAN), such as any standards related to the Third Generation Partnership Project (3GPP), including, for example, a third generation (3G) cellular network, a universal mobile telecommunication system (UMTS), a fourth generation (4G) cellular network, a long term evolution (LTE®) cellular network, a long term evolution licenses assisted access (LTELAA) cellular network, a fifth generation (5G) cellular network, New Radio (NR) cellular network, a cellular network beyond 5G, a satellite network, and so on. In particular, the network interface 34 may include, for example, one or more interfaces for using a Release-15 cellular communication standard of the 5G specifications that include the millimeter (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 34 of the user equipment 12 may allow communication over the aforementioned networks (e.g., 7G, Wi-Fi, LTE-LAA, and so forth).

The network interface 34 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 34 includes a transceiver 38. In some embodiments, all or portions of the transceiver 38 may be disposed within the processor 22. The transceiver 38 may support transmission and receipt of various wireless signals via one or more antennas, and thus may include a transmitter and a receiver. The power source 36 of the user equipment 12 may include any suitable source of power, such as a rechargeable lithium polymer (Li-poly) battery and/or an alternating (AC) power converter.

The sensors 37 of the user equipment 12 may include one or more motion sensors, one or more temperature sensors, one or more light sensors, one or more pressure sensors, one or more cameras or image sensors, or any other suitable sensors. In certain embodiments, the motion sensors may include an inertial measurement unit (IMU), a three-dimensional accelerometer, a three-dimensional gyroscope, or the like, that may detect a motion of the user equipment 12. For example, the IMU may detect a rotation of the user equipment 12, a rotational movement of the user equipment 12, an angular displacement of the user equipment 12, a tilt of the user equipment 12, an orientation of the user equipment 12, a linear motion of the user equipment 12, a non-linear motion of the user equipment 12, or the like. The temperature sensors may include a temperature sensor that may measure a temperature of an oscillator of a GNSS receiver of the user equipment 12, an internal temperature of the user equipment 12, a circuit junction temperature of the user equipment 12, an external temperature of the user equipment 12, or the like. Temperature measurements from the temperature sensors can be provided as input to a thermal arbiter executing on processor 22. The light sensors may detect a quantity of ambient light external to the user equipment 12. The pressure sensors may include, for example, a barometer, that may detect an atmospheric pressure associated with the user equipment 12. The sensors 37 may additionally or alternatively include one or more cameras, such as onboard cameras for visual inertial odometry and/or other suitable position/location sensing techniques.

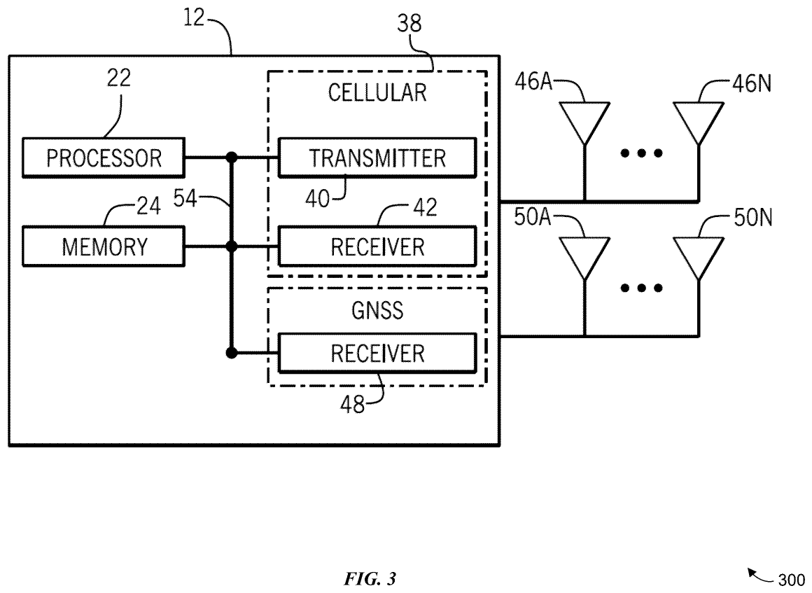

FIG. 3 is a functional diagram of the user equipment 12 of FIGS. 1 and 2, according to embodiments of the present disclosure. As illustrated, the processor 22, the memory 24, the transceiver 38, a transmitter 40, a receiver 42, antennas 46 (illustrated as 46A-46N, collectively referred to as an antenna 46), and/or a GNSS receiver 48 may be communicatively coupled directly or indirectly (e.g., through or via another component, a communication bus, a network) to one another to transmit and/or receive data between one another.

In particular, the transceiver 38 may be in the form of a cellular transceiver 38 having a cellular transmitter 40 and/or a cellular receiver 42 that respectively enable transmission and reception of cellular signals between the user equipment 12 and an external device via, for example, a cellular network (e.g., including base stations, such as NodeBs, eNBs or eNodeBs (Evolved NodeBs or E-UTRAN (Evolved Universal Mobile Telecommunication System (UMTS) Terrestrial Radio Access Network) NodeBs, or gNBs or gNodeBs (e.g., Next Generation NodeB)). As illustrated, the cellular transmitter 40 and the cellular receiver 42 may be combined into the cellular transceiver 38.

Additionally, the user equipment 12 may also include the GNSS receiver 48 that may enable the user equipment 12 to receive GNSS signals from a GNSS network (e.g., GNSS network 18 of FIG. 1), including one or more GNSS satellites (e.g., GNSS satellites 20 of FIG. 1) or GNSS ground stations. The GNSS signals may include a GNSS satellite's observation data, broadcast orbit information of tracked GNSS satellites, and supporting data, such as meteorological parameters, collected from co-located instruments of a GNSS satellite. For example, the GNSS signals may be received from a Global Positions System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on.

As described above, the GNSS receiver 48 may receive GNSS signals from the GNSS satellites 20 and process the signals to determine a global position of the user equipment 12. In particular, each GNSS satellite 20 may transmit one or more pilot channels alongside a data signal. Each pilot channel is a dataless signal transmitted from a corresponding GNSS satellite 20. The user equipment 12 may process one or more of the pilot channels from one or more GNSS satellites 20 to determine the position of the user equipment 12.

The GNSS receiver 48 may process the received pilot channels of the GNSS signals from each GNSS satellite 20 to amplify the power of the pilot channels, generate and maintain tracking loops for each pilot channel, and determine the position of the user equipment 12 based on each pilot channel. For instance, the GNSS receiver 48 may amplify the power of the pilot channels and generate the tracking loop for each pilot channel by performing a series of signal processing operations based on the received pilot channel. The GNSS receiver 48 may then perform a radio frequency (RF) down-conversion operation, a sampling operation, a Doppler removal operation, a coherent signal integration operation, and a non-coherent summation operation based on the received pilot channel. However, in certain embodiments, it should be understood that the GNSS receiver 48 may perform the signal processing operations in different sequences than the sequence described, and certain operations may be skipped or not performed altogether.

The GNSS receiver 48 may include a frequency stability prediction engine, which may be implemented as hardware (e.g., circuitry), software (e.g., instructions stored in the memory 24 and/or the storage 26), or both (e.g., as logic). As mentioned above, during the coherent signal integration operation performed by the GNSS receiver 48 against a pilot channel of a received GNSS signal, the GNSS receiver 48 integrates the pilot channel over a coherent period of time to generate a resulting signal with a particular signal to noise ratio (SNR). Thereafter, during the non-coherent summation operation, the resulting signal is squared to increase the signal gain. Generally, a higher SNR in the resulting signal generated from the coherent signal integration operation will minimize a squaring loss that is incurred in the resulting signal from squaring the noise present in the resulting signal during the noncoherent summation operation. As such, by minimizing the squaring loss in the resulting signal from the non-coherent summation operation, the quality of the signal is increased, thereby increasing an accuracy in determining the position of the user equipment.

However, a number of factors may affect the signal during the coherent signal integration operation, which can decrease the SNR in the resulting signal. For instance, such factors may affect oscillator dynamics of the user equipment 12, such as motion experienced by a reference oscillator of the GNSS receiver 48 or thermal changes experienced by the reference oscillator of the GNSS receiver 48, and user dynamics associated with the user equipment 12, such as motion of the user equipment 12, thermal changes associated with the user equipment 12, and the like. Accordingly, the frequency stability prediction engine of the GNSS receiver 48 may dynamically adjust the coherent period of time for performing the coherent signal integration operation against the pilot channel of the GNSS signal based on various types of data associated with the user equipment 12. For instance, the frequency stability prediction engine of the GNSS receiver 48 may receive data from one or more sensors 37 associated with the user equipment 12 that are indicative of current and/or expected conditions associated with the user equipment 12 (e.g., motion, temperature, light, pressure, and so on). In certain embodiments, the data may be indicative of a temperature associated with the reference oscillator of the GNSS receiver 48, the user equipment, or both; an expected change in temperature associated with the reference oscillator of the GNSS receiver 48, the user equipment, or both; a motion associated with the reference oscillator of the GNSS receiver 48, the user equipment, or both; an expected change in motion associated with the reference oscillator of the GNSS receiver 48, the user equipment, or both; or the like.

In some embodiments, the user equipment 12 may determine a current motion associated with the user equipment 12 or an expected motion associated with the user equipment 12 based on data from the sensors 37. For instance, the user equipment 12 may determine an orientation, a position, or both, of the user equipment 12 with respect to a user of the user equipment 12. The user equipment 12 may determine that the orientation or the position of the user equipment 12 is indicative of a stationary orientation or position of the user equipment 12, a changing orientation or position of the user equipment 12, or the like. For instance, the user equipment 12 may determine that the user is holding the user equipment 12 in a hand of the user, the user is walking with the user equipment 12 in a hand of the user, the user is jogging with the user equipment 12 in a hand of the user, the user is running with the user equipment 12 in a hand of the user, the user is carrying the user equipment 12 in a pocket of the user, the user is walking with the user equipment 12 in a pocket of the user, the user is jogging with the user equipment 12 in a pocket of the user, the user is running with the user equipment 12 in a pocket of the user, the user is driving a vehicle with the user equipment 12 in the vehicle, and the like. The frequency stability prediction engine of the GNSS receiver 48 may receive data indicative of the orientation or the position of the user equipment 12 from the user equipment 12 (e.g., the processor 22, the memory 24, the storage 26).

The frequency stability prediction engine of the GNSS receiver 48 may also receive other suitable types of data or information from the user equipment 12 that are indicative of factors that may affect the pilot channel of the GNSS signal during the coherent signal integration operation. For instance, the frequency stability prediction engine of the GNSS receiver 48 may receive data indicative of an upcoming transmission from an antenna associated with the user equipment 12, data indicative of a powering down of an antenna associated with the user equipment 12, data indicative of a powering on of a cellular power amplifier associated with the user equipment 12, data indicative of a powering down of a cellular power amplifier associated with the user equipment 12, or the like. The frequency stability prediction engine may receive information indicating the current or predicted oscillator temperature from the thermal manager.

After receiving data associated with the user equipment 12 that may be indicative of one or more factors that may affect the pilot channel of the GNSS signal during the coherent signal integration operation, the frequency stability prediction engine of the GNSS receiver 48 may determine a corresponding period of time (e.g., a coherent period of time) for performing the coherent signal integration operation (e.g., coherent operation) against the pilot channel of the GNSS signal. In certain embodiments, the frequency stability predication engine of the GNSS receiver 48 may compare the data received from the user equipment 12 pre-defined values of the coherent period of time (e.g., stored in a look-up table in the memory 24 or the storage 26). For instance, the different values for the coherent period of time may be associated with one or more data inputs indicative of the respective factors that may affect the pilot channel of the GNSS signal during the coherent signal integration operation. In some embodiments, the values of the coherent period may be pre-determined by a manufacturer of the user equipment 12. In other embodiments, the user equipment 12 may receive one or more updates to the values over time to update the values of the coherent period that correspond to the data inputs indicative of the respective factors that may affect the pilot channel of the GNSS signal during the coherent signal integration operation.

After the frequency stability prediction engine of the GNSS receiver 48 determines a corresponding coherent period of time for performing the coherent signal integration operation against the pilot channel of the GNSS signal, the GNSS receiver 48 may perform the coherent signal integration against the pilot channel of the GNSS signal using the determined coherent period of time. By adjusting the coherent period of time for performing the coherent signal integration operation to account for current and/or expected conditions associated with the user equipment 12, a higher SNR of the resulting signal may be obtained. In this way, the squaring loss that is incurred in the resulting signal from squaring any noise present in the resulting signal during the subsequent non-coherent summation operation may be decreased or minimized, thereby increasing the quality of the signal for determining the position of the user equipment 12.

The user equipment 12 may also have one or more antennas 46A-46N (collectively 46) electrically coupled to the cellular transceiver 38, and one or more antennas 50A-50N (collectively 50) electrically coupled to the GNSS receiver 48. The antennas 46, 50 may be configured in an omnidirectional or directional configuration, in a single-beam, dualbeam, or multi-beam arrangement, and so on. Each antenna 46, 50 may be associated with one or more beams and various configurations. In some embodiments, multiple antennas of the antennas 46, 50 of an antenna group or module may be communicatively coupled to a respective transceiver 38 or the GNSS receiver 48 and each emit radio frequency signals that may constructively and/or destructively combine to form a beam. The user equipment 12 may include multiple transmitters, multiple receivers, multiple transceivers, and/or multiple antennas as suitable for various communication standards.

As illustrated, the various components of the user equipment 12 may be coupled together by a bus system 54. The bus system 54 may include a data bus, for example, as well as a power bus, a control signal bus, and a status signal bus, in addition to the data bus. The components of the user equipment 12 may be coupled together or accept or provide inputs to each other using some other mechanism.

### II. Simulated Signal Paths

GNSS systems may use the time-of-flight for a satellite's signal to estimate the distance between the satellite and a GNSS receiver. Such systems may produce inaccurate location determinations in environments where the signal cannot travel to the receiver along a line-of-sight path. For example, a signal may reach a receiver after reflecting off of a building, and the added time-of-flight may incorrectly increase the estimated distance between the satellite and receiver.

Errors caused by non-line-of-sight flight paths can be mitigated using simulated signal paths. Instead of assuming line-of-sight flight paths, a mobile device implementing GNSS techniques can generate simulated flight paths between potential receiver locations and the satellite. The mobile device can use ray tracing techniques, and a building model, to estimate reflected flight paths between potential receiver locations and one or more satellites. The distances (e.g., pseudoranges) for estimated flight paths can be compared against measured pseudoranges from satellite signals to estimate the mobile device's location.

### A. Ray Tracing to Simulate Non-Line-of-Sight Signal Paths

Ray tracing techniques can be used generate simulated non-line-of-sight signal paths. A mobile device that is implementing ray tracing can project simulated signal paths from a number of potential locations and at a variety of angles. The mobile device can simulate the signal's reflection off of buildings or other features that would obstruct a GNSS signal. The simulated signal paths may better match a measured signal's flight path in particular environments such as a dense urban area (e.g., an area a high building density).

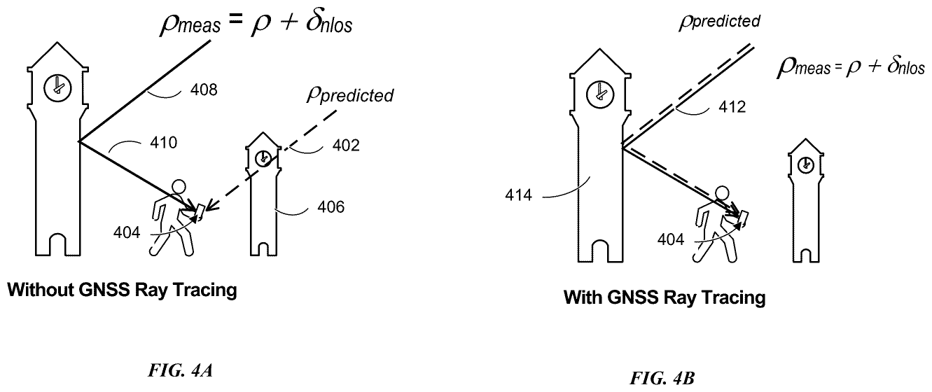

FIGS. 4A-4B show simplified diagrams 400-401 of non-line of sight Global Navigation Satellite System (GNSS) location determinations according to various embodiments. As shown in FIG. 4A, generally GNSS systems assume a line-of-sight flight path (e.g., ρ_{predicted} 402) between a signal source and a receiver 404. To determine a location without ray tracing, the receiver 404 measures a time of flight for three or more signals that are received from GNSS satellites. The receiver 404 uses these signals to determine a location for the receiver within a line-of-sight search space. The line-of-sight search space is constrained to limit the number of possible solutions, and, for example, the search space may be limited to solutions where the receiver 404 is at ground level and the time-of-flight measurements correspond to a point-to-point line-of-sight flight path between the receiver 404 and satellite.

However, a line-of-sight path between a signal source (e.g., a satellite) and the receiver 404 may not be possible in all environments. For example, in dense urban areas, like downtown San Francisco and Chicago (e.g., places with big buildings), the signal may not be received via line-of-sight because the signal's path is occluded by a building (e.g., building 406) or other structures. For example, a signal may not be able to travel along the predicted line of sight path ρ_{predicted} 402 to the receiver 404 because the line-of-sight path would be blocked by building 406.

Instead of following a line-of-sight path ρ_{predicted} 402, the path of the measured signal ρₘₑₐₛ may be via a combination of a line-of-sight path p 408 and one or more non-line-of-sight path delays δₙₗₒₛ 410. These non-line-of-sight paths can cause inaccurate location determinations because the distance between the satellite and the receiver 404 may differ from the predicted line of sight path ρ_{predicted} 402. For example, the receiver may be at a location that is not within a line-of-sight search space because, without ray tracing, the receiver may not consider solutions where the signal is reflected off of a building. Accordingly, the receiver's actual location and the predicted location may differ by the length of the non-line-of-sight path delay.

Turning now to FIG. 4B, ray tracing can be used to improve the accuracy of global navigation satellite system (GNSS) location determinations when line-of-sight flight paths between the receiver 404 and the signal source are not available. Instead of assuming that the solution is a line-of-sight path, the receiver 404 can use ray tracing, and a building model, to expand the search space to include non-line-of-sight paths 412. The receiver 404 can use a building model that includes building locations and dimensions to project flight paths (e.g., rays) in all directions from potential receiver 404 locations. For example, non-line-of-sight path corresponds to a ray that reflects off of building 414. The receiver's location can be identified as the origin point for a ray if the ray's time of flight corresponds to the receiver's signal time of flight, and the ray intersects with the satellite's location (e.g., the ray is within a threshold distance of the satellite's location).

### B. Simulated Signal Path Refinement Using Satellite Locations

Simulated signal paths can be refined by adjusting the path based on a satellite's location. Large numbers of simulated paths may be projected for locations within an area around a mobile device's last location. However, these locations may be separated from the satellite by extremely large distances, and small errors in the simulated flight path may mean that there are large distances between the simulated path's trajectory and the satellite's location. The satellite's location is known, and the simulated signal paths can be refined by adjusting a simulated signal path if the path's trajectory is close to the satellite's location.

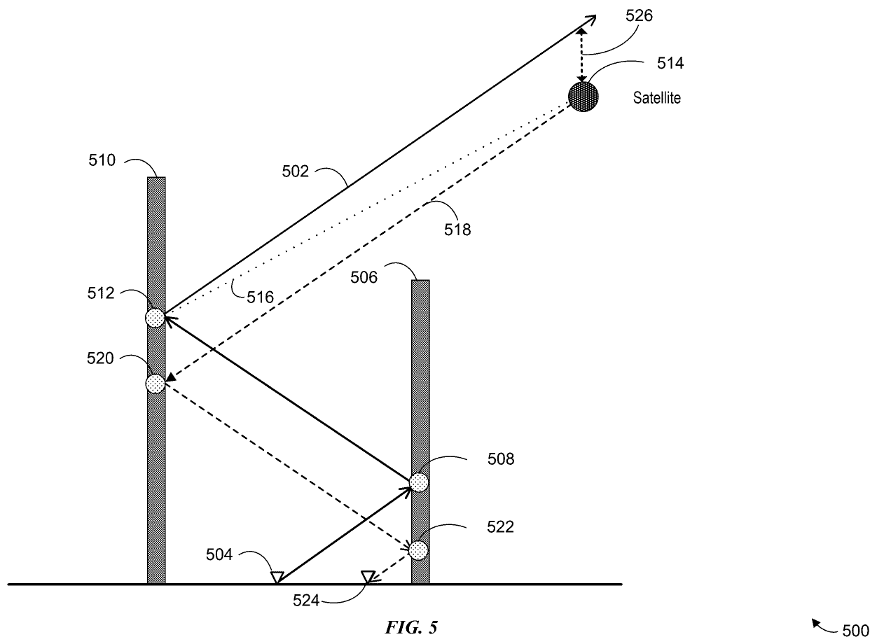

FIG. 5 is a simplified diagram 500 showing ray tracing for a global navigation satellite system (GNSS) according to various embodiments. Rays can be simulated for a grid of points around a receiver's last location (e.g., the receiver's last GNSS location). The grid can include a finite number of points that are evenly spaced in an area around the receiver's last location. The area can be a distance from the receiver's last location (e.g., a 100-meter circle around the receiver's last location). In some embodiments, the points in the grid can be assigned different weights, and, for example, the points may be weighted based on the distance from the receiver's last location (e.g., closer points are assigned higher weights).

Rays can be projected from grid points, and a building model can be used to calculate non-line-of-flight paths from the receiver. Multiple rays can be projected for a grid point, and each ray can correspond to a different orientation. For example, the ray's orientation can be defined by a three-dimensional unit vector, and the unit vector may change between each ray's projection. The number of rays that are projected at a point can be any one of 10 rays, 50 rays, 100 rays, 500 rays, 1000 rays, 2000 rays, 3000 rays, 4000 rays, 5000 rays, 10,000 rays, 20,000 rays, 30,000 rays, 40,000 rays, and 50,000 rays. The number of candidate points can be 10 candidate points, 50 candidate points, 100 candidate points, 500 candidate points, 1000 candidate points, 2000 candidate points, 3000 candidate points, 4000 candidate points, 5000 candidate points, 10,000 candidate points, 20,000 candidate points, 30,000 candidate points, 40,000 candidate points, and 50,000 candidate points.

Accordingly, ray tracing may involve generating a large number of rays. However, it is unlikely that a ray will intersect with a satellite because the satellites may orbit at extremely high altitudes. For example, a satellite may orbit at 20,000 kilometers above the earth's surface, and even small differences in a ray's orientation can result in a large distance between the ray's path and the satellite's location. The satellite's position may be known, and this information can be used to refine a candidate point's location by adjusting a ray's origin point so that the ray intersects with the satellite's known location. The adjusted origin point for a ray can be a refined candidate point.

Turning now to FIG. 5 in greater detail, an outgoing ray 502 can be projected from candidate point 504. The outgoing ray 502 may reflect off of a first building 506 at reflection point 508 and the outgoing ray 502 may reflect off of a second building 510 at reflection point 512. The buildings and reflection points can be calculated by the receiver 504 using a building model. Outgoing ray 502 may be suitable for adjustment because the ray's trajectory towards the satellite 514 (e.g., the trajectory from reflection point 512) is within an angle threshold of the actual trajectory 516 to the satellite 514. The angle threshold can be a 0.1% difference, a 0.5% difference, a 1% difference, a 1.5% difference, a 2% difference, a 3% difference, a 4% difference, and a 5% difference.

The candidate point 504 can be adjusted by changing ray 502 so that the ray intersects with the satellite 514. Adjusting the ray can mean changing the position of ray 502 without changing the ray's reflection angles. This can be done by projecting a ray from the satellite 514 towards the candidate point 504. This adjusted ray 518 can have the same three-dimensional trajectory as the outgoing ray 502, but the ray's endpoints may be different. In this case, the path of ray 502 and satellite 514 differ by a gap 526, and adjusted ray 518 can be produced by changing the path of ray 502 to minimize the gap 526. To preserve the reflection angles, the reflection point 512 is changed to adjusted reflection point 520, reflection point 508 is changed to adjusted reflection point 522, and candidate point 504 is changed to adjusted candidate point 524.

### C. Matching Simulated Signal Paths to Signal Measurements

Signal measurements can be compared against simulated signal paths to determine a measured signal's flight path. The measurements can be used to determine a distance (e.g., pseudorange) for the flight path. The measured pseudorange can be compared against a simulated pseudorange to determine a GNSS receiver's likely location.

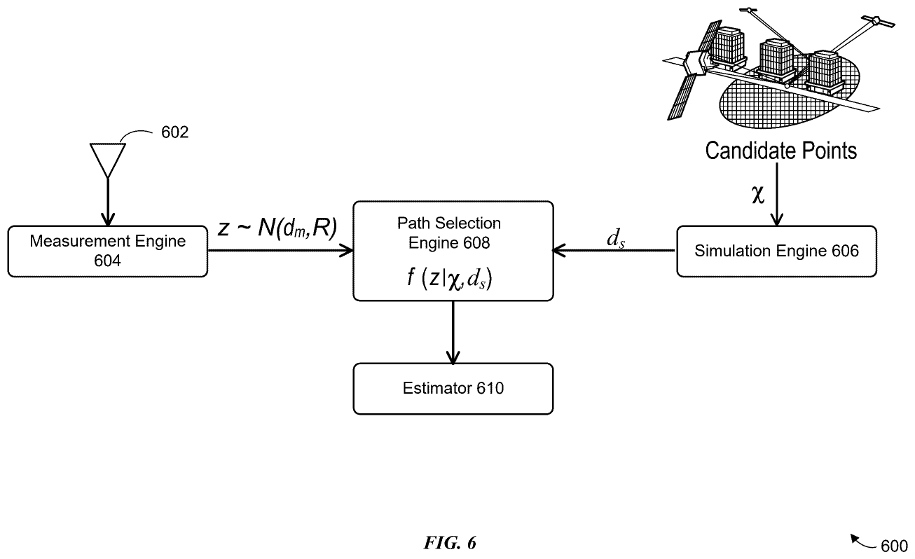

FIG. 6 shows a block diagram of a ray tracing architecture for a global navigation satellite system (GNSS) according to various embodiments. Ray tracing can be used to simulate signal path delays for a search space of candidate locations around a receiver's last known location. The simulated signal delays can be compared against measured pseudoranges to identify likely receiver locations. A measured pseudorange can be determined for each satellite, and the measured pseudorange may be determined from one or more signals between the antenna and the satellite (e.g., by averaging multiple pseudoranges).

Signals from GNSS satellites can be received at antenna 602 and the management engine 604 can determine a pseudorange z for the received signal from each available satellite. The pseudorange z can correspond to a measured path delay dm and a covariance matrix R for a signal between the antenna 602 and a satellite. A covariance matrix can be a representation of the statistics of the error between a measured pseudorange z and the predicted pseudorange constructed from models of all the input error sources. the covariance matrix R can represent error statistics between the measured pseudorange z and the predicted pseudorange. The covariance matrix can be used to model errors such as clock biases, ionospheric delays, tropospheric delays, and delays caused by the rotation of the earth/satellite orbit during the signal's propagation. The measured path delay dₘ can be the added time of flight caused by non-line-of-sight paths. The measured path delay dₘ from pseudorange z can be matched against simulated path delays dₛ to determine a likely position for the antenna 602. For example, the most likely candidate point x may minimize the aggregate difference between measured path delay dₘ and the observed path delay dₛ across the received signals.

Simulated path delays dₛ for candidate points x can be generated by the simulation engine 606 using ray tracing techniques. Rays can be projected from each candidate point x at a number of different angles, and the simulation engine 606 can use a building model to simulate non-line-of-sight paths for rays that intersect with buildings. The rays may be filtered to remove flight paths that do not intersect with a satellite's known position (e.g., with a threshold distance of the satellite's position). The simulation engine 606 can determine a simulated path delay dₛ for a candidate point x by comparing the simulated time-of-flight for a non-line-of-sight signal path (e.g., a flight path that is calculated using the building model) against a theoretical line-of-sight the time-of-flight path at the candidate point x (e.g., a flight path that is calculated without the building model). The simulated path delay dₛ can be the difference in time between the line-of-sight time-of-flight and non-line-of-sight time-of-flight. Therefore, a pseudorange may correspond to this non-line-of-sight flight path if the simulated path delay dₛ matches (e.g., is within a threshold time difference of) the measured path delay dₛ, but it may not be possible to separate the measured signal delay dₘ and the covariance matrix R from a pseudorange z. However, candidate positions may be generated for a relatively small geographic area and the covariance matrix R may not vary significantly within this area. Accordingly, a pseudorange z can be used as a proxy for the measured signal delay dₘ. In some implementations, the number of candidate positions and/or the size of the geographic area can be determined by a position uncertainty of the last position that was determined for the mobile device.

$$f ( z \vert x , {d}_{s} ) = \frac{1}{{( 2 π )}^{n / 2} \sqrt{\vert R \vert}} exp \{ - \frac{1}{2} {( z - Hx - {d}_{s} )}^{T} {{R}^{- 1} ( z - Hx - {d}_{s} )}^{T} \}$$

A path selection engine 608 can compare the simulated delays dₛ against the pseudorange z for each satellite to determine a probability that the antenna 602 is at each candidate point. The path selection engine 608 can use a probability density function to determine the probability that a simulated path delay dₛ for a candidate point x corresponds to a pseudorange z for a signal between a satellite and the antenna 602. The maximum likelihood selector equation for the probability density function is reproduced below:

Where z is a vector of measurements, dₛ represents path delays, and H is the Jacobian of the measurements. In some embodiments, the term Hx with the LOS path (z_los) between the given the user location (x) and the satellite location. In some embodiments, the path selection engine 608 may determine separate probabilities for each satellite. These probabilities can be provided to an estimator 610 by the path selection engine 608, and the estimator can use the probabilities to estimate a location for the antenna 602. The path selection engine 608 can compute the likelihood of observing the measurements, z, at location x, with path delays dₛ (and covariance matrix R). The output of the path selection engine 608 can be values for x and dₛ that maximize the likelihood of observing measurements z at location x with path delay dₛ.

### III. Multiple Simulated Signal Measurements Per Satellite

A signal from a satellite can arrive at a receiver's antenna along multiple paths. Each received signal can be treated as an independent measurement, and the measurements can be matched to simulated signal paths. A location that is determined using multiple measurements for a single signal can improve location accuracy because fewer candidate locations are likely to match all of the measurements.

### A. Virtual Satellites

Non-line-of-sight flight paths can be used to determine multiple measurements for each satellite. A satellite's signal can reach a GNSS receiver via multiple reflected paths, and the measured signal for each reflected flight path can be a separate measurement. The measurements can be matched to separate simulated signal paths and the measurements may be treated as originating from different virtual satellites. These measurements can be used to locate determine the GNSS receiver's location.

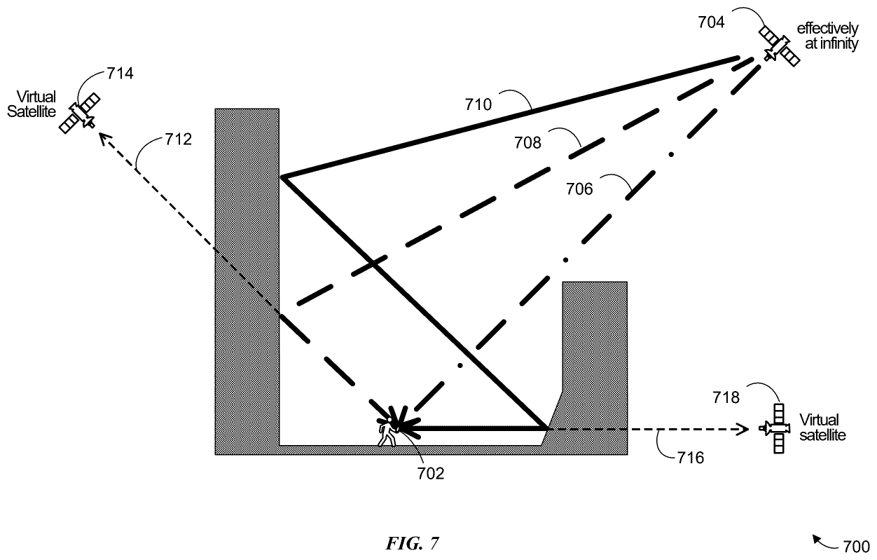

FIG. 7 is a simplified diagram 700 showing multiple measurements for a signal from a satellite according to various embodiments. Receiver 702 can measure a signal from satellite 704, however, a single signal transmission from the satellite 704 may take multiple paths to the receiver 702. As shown in FIG. 7, the signal arrives at receiver 702 along three separate paths: a line-of-sight path 706, non-line-of-sight path 708, and non-line-of-sight path 710. The receiver 702 can perform several measurements for each signal transmission by satellite 704 (e.g., one measurement for each path 707-710).

Receiver 702 may record a reception time for each signal measurement. The received signals may include information that can be used to identify a transmission time, and the receiver 702 may use the reception time and transmission time to determine a pseudorange for each signal measurement. For example, the received signal pattern that varies over time (e.g., a code). The received signals code can be compared against a local copy of the code and the phase difference between these codes can be a delay between the signal's transmission and reception. The delay can be used to determine a pseudorange for the signal by modifying the delay with one or more additional delays (e.g., ionospheric delay and tropospheric delays) and multiplying the modified delay by the speed of light.

A pseudorange can be a distance measurement that is estimated from a received signal. The pseudorange may include time synchronization errors between any combination of any number of the receiver, the satellite, and an external reference time source. The pseudorange and estimated time-of-flight measurements from ray tracing can be used to match signal measurements to the signal paths. Information about the signal path (e.g., the angle of arrival for the signals) can be recorded in a Jacobian matrix, and the Jacobian matrix can be used to transform the information about the signal path into a linear format. Accordingly, each signal that corresponds to a non-line-of-sight flight path can be treated as a line-of-sight signal from a virtual satellite. For example, the signal for non-line-of-sight path 708 can be treated as a signal with linear path 712 that originates from virtual satellite 714. The signal corresponding to non-line-of-sight path 710 can be treated as a linear path 716, and the signal can be treated as originating from virtual satellite 718.

The formula for the location of receiver 702 relative to a virtual satellite can be represented in equation (1) as:

$$δ \vec{x} = {( {H}^{T} {R}^{- 1} H )}^{- 1} {H}^{T} {R}^{- 1} δ \vec{z} \qquad ( 1 )$$

Where δ\vec{x} is a vector representing the receiver location's error, H is a Jacobian matrix of the non-line-of-sight paths from the transmitting satellite to the receiver, R is a covariance matrix matrix of the measurement errors, and δ\vec{z} is a misclosure vector representing the difference between the true and estimated measurements. The true measurements can be pseudoranges that are measured by from satellite signals, and the estimated measurements can be pseudoranges for simulated signal paths.

A least squares approach can be used to determine a set of non-line-of-sight paths that minimize the receiver location's error δ\vec{x}. The approach can include iteratively solving equation (1) using values for H and δ\vec{z} that correspond to different sets of simulated non-line-of-sight paths until a minimum value of δ\vec{x} is found. More details about GNSS estimations can be found in the following article which is incorporated for all purposes: Petovello, Mark. “How do Measurement Errors Propagate into GNSS Position Estimates” Inside GNSS, August 2014, pp. 30-34.

### B. Ambiguity Function

The mobile device can determine a measured signal's properties using an ambiguity function. A signal's properties can be used to determine which satellite transmitted the signal and the signal's transmission time. The mobile device can determine the measured signals properties by generating local copies of the transmitted signal and comparing the measured signals against the local copies using an ambiguity function. The output of the ambiguity function can be a three dimensional graph, and peaks in the graph can be used to determine measured signal properties.

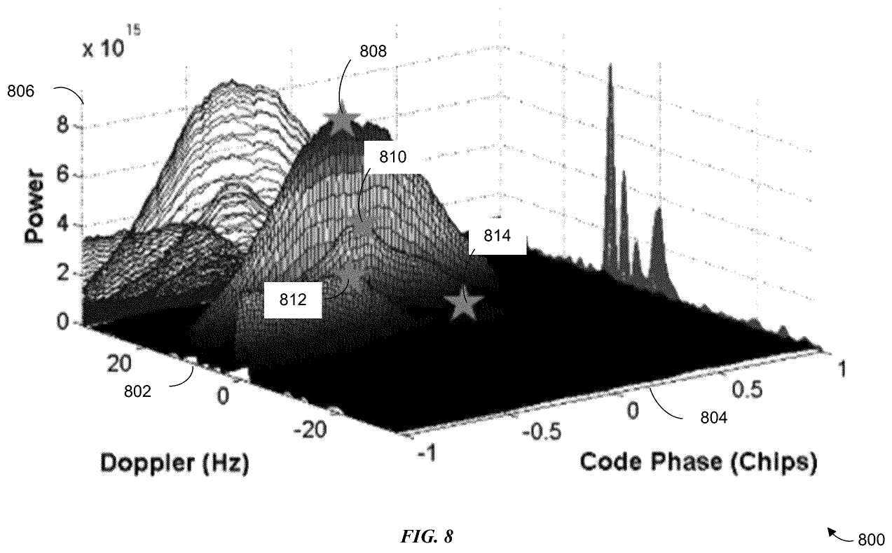

FIG. 8 is a simplified graph of the output of an ambiguity function according to various embodiments. The properties of the received signal can be determined by finding a local version of the signal that maximizes the output of the ambiguity function (e.g., a matching signal). The properties of the received signal can be assumed to be the properties of the matching signal.

The output of the ambiguity function can be the magnitude of a correlation between the received signal and a local version. The local versions of the signal can be generated by varying the frequency (e.g., x-axis 802) and the start time (e.g., code phase 804) of a locally generated signal. The magnitude of the correlation between a received signal and a local signal can be shown on the z-axis 806. In a one-to-one channel architecture, the matching signal can be identified as a signal with the frequency and start time that correspond to the maximum correlation value (e.g., the maximum value on z-axis 806). For example, global maximum 808 can correspond to a matching signal. More details about generating a matching signal using an ambiguity function can be found at: Petovello, M., Motella, B., & Lo Presti, L. (2010). The Math of Ambiguity. InsideGNSS, 20-28.

### C. One-to-One Channel Architecture

Multiple signal measurements can be performed for a single transmission by allocating multiple hardware channels to a single satellite. A hardware channel can be the hardware and software that are used to measure a signal from a satellite (e.g., transceiver 38 and antennas 46A-46N).

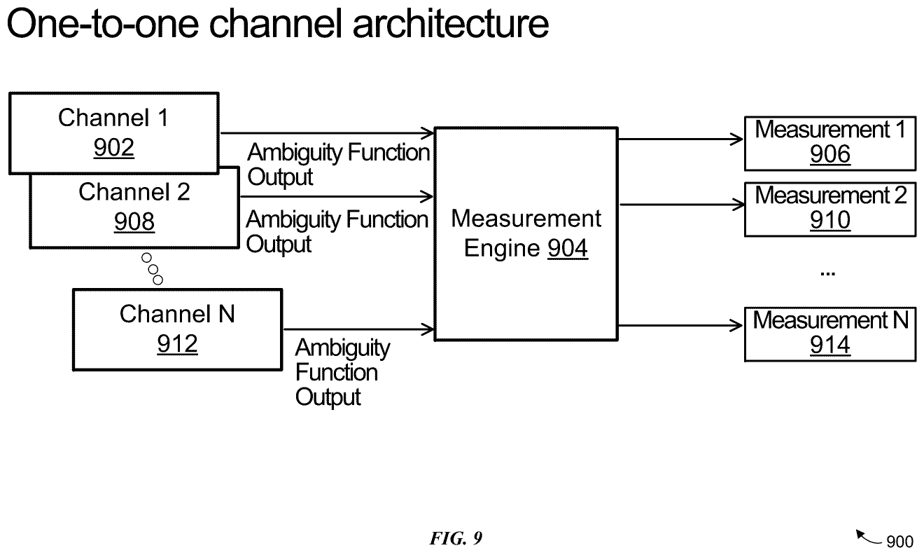

FIG. 9 shows a simplified block diagram of a one-to-one channel architecture 900 according to various embodiments. In the architecture 900, a single channel can correspond to a single measurement of a signal from a satellite (e.g., a pseudorange). The measurements can be identified for each channel by the measurement engine 904 (e.g., measurement engine 604). For example, channel 1 902 can correspond to measurement 1 906, channel 2 908 can correspond to measurement 2 910 and channel N 912 can correspond to measurement N 914. Each channel can measure a signal by generating local versions of an expected signal from a satellite. The code phase and frequency can be varied between versions, and the local versions of the signal can be compared to a received signals using an ambiguity function. Each channel can provide the output of the ambiguity function (e.g., graph 800) to the measurement engine 904.

The one-to-one channel architecture 900 can be resource intensive. For example, the receiver may need to generate an ambiguity function for each received signal. In addition, a global navigation satellite system receiver may have a finite number of channels (e.g., 100), and the number of measured signals is limited by the number of available channels. The one-to-one channel architecture 900 may include allocating and deallocating channels during signal acquisition. For example, a receiver may allocate 10 channels to measure signals from a satellite. However, more channels may be allocated to the satellite if a signal is measured by each channel (e.g., because there may be unmeasured signals from the satellite). Alternatively, channels may be deallocated from the satellite if one or more of the channels do not find a matching signal from the satellite (e.g., the maximum value output by the ambiguity function is below a threshold).

### D. One-to Many Channel Architecture

A one-to-many channel architecture may reduce the resource requirements for acquiring multiple signals from a single satellite. Instead of allocating a channel for each measured signal, a measurement engine in the one-to-many channel architecture can identify multiple signals from a single channel's ambiguity function. In a one-to-one channel architecture, the output of an ambiguity function is analyzed by the measurement engine to identify a global maximum value (e.g., peak 808), and this maximum value is identified as the matching signal. In a one-to-many channel architecture, the global maximum, and one or more local maxima, can be identified as matching signals. For example, peak 810, peak 812, and peak 814 in FIG. 8 can be identified as local maxima that correspond to received signals.

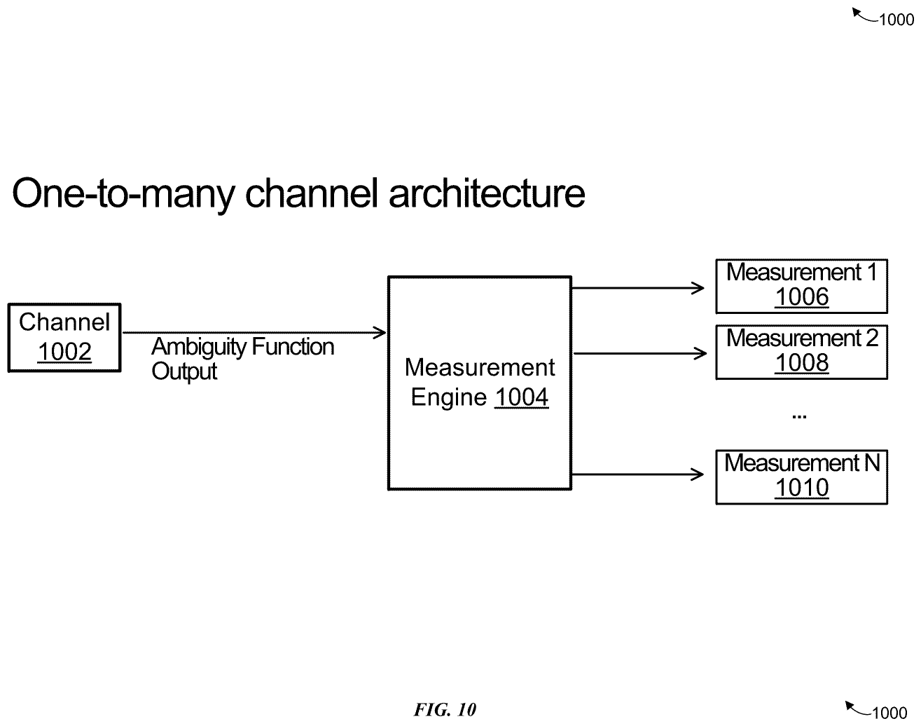

FIG. 10 shows a simplified diagram of a one-to-many channel architecture 1000 according to various embodiments. A receiver that is implementing the one-to-many channel may assign a single channel to each available satellite; however, the receiver can assign any number of channels to any number of satellites. Channel 1002 can use an ambiguity function to compare signals that are received from a satellite against local versions of the signal. The channel 1002 can identify both primary measurements and secondary measurements from the output of the ambiguity function. A primary measurement can be a global maximum value (e.g., peak 808 from FIG. 8), and a secondary measurement can be a local maximum (e.g., peak 810, peak 812, and peak 814). A local maximum can be a value that is greater than or equal to all adjacent values.

The measurement engine 1004 can identify primary measurements and secondary measurements from the output of channel 1002. The output of channel 1002 can be a graph such as graph 800. The measurement engine 1004 may use simulated path delays that are output by a simulation engine (e.g., simulation engine 606) to identify primary measurements and secondary measurements. In some embodiments, the measurement engine 1004 may use estimated paths from an estimator (e.g., estimator 610) to determine primary measurements and secondary measurements.

### IV. GNSS Architecture

A global satellite navigation system (GNSS) can use software and hardware to measure satellite signals. The architecture can include one or more channels, and the channels can include receivers, antennas, and tuning banks. The channel's parameters can be varied to generate ambiguity functions and measure GNSS signals as described above.

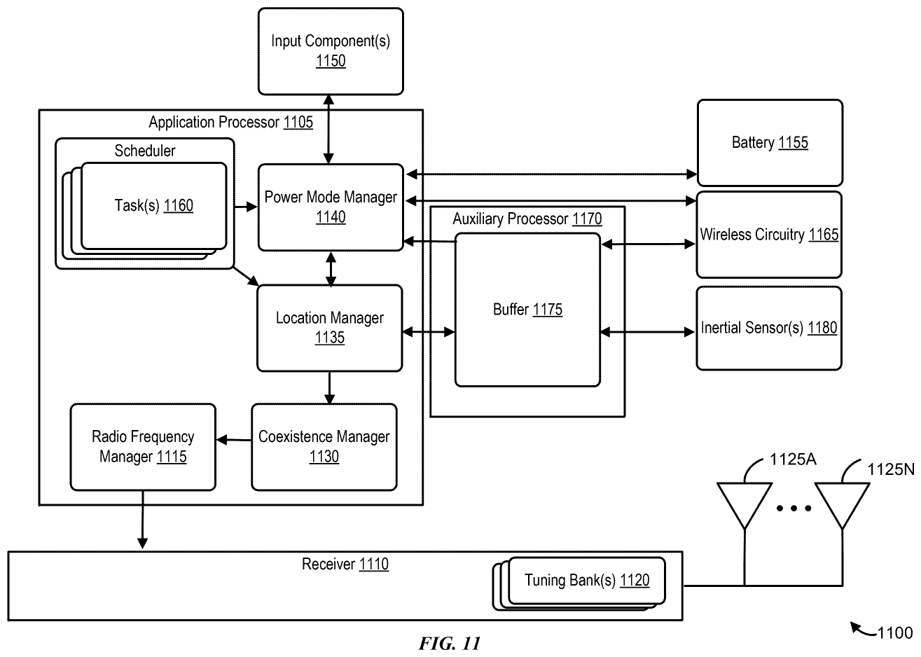

FIG. 11 is a simplified diagram 1100 of an architecture for GNSS navigation according to various embodiments. Processes executing on application processor 1105 can implement tuning logic and instruct receiver 1110 to perform GNSS measurements using the GNSS circuitry or change the tuning state for one or more antennas. Application processor 1105 can be part of a mobile device such as user equipment 12. In addition, receiver 1110 can be similar to receiver 118 and application processor 1105 and auxiliary processor 1170 can be similar to processor 22 described above. Instructions to the receiver 1110 can be sent by a radio frequency manager 1115 and the receiver can perform GNSS measurements or connect or disconnect one or more of the tuning bank(s) 1120 to the antennas 1125a-1125n in response to the instructions. Changing the tuning bank(s) 1120 can change the tuning state for the antennas 1125a-1125n and the performing GNSS measurements may involve changing the tuning state for these antennas.

The tuning logic can be implemented by the coexistence manager 1130 which can integrate information from the other processes executing on processor 1105 to make decisions about changing the tuning state. Upon determining that the tuning state should change, the coexistence manager 1130 can instruct the radio frequency manger to change the tuning state for antennas 1125a-1425n. The tuning logic can include changing the tuning state based on the GNSS mode (e.g., acquisition, or tracking), the thermal state (e.g., thermal event; whether temperature is stable or fluctuating), or the power state of the mobile device (e.g. the charge in the device's battery; whether the device is charging).

Location manager 1135 can process signals received at the antennas and provide information about the current GNSS mode to the coexistence manager 1130. Signals received at the antennas 1125a-1125n can be forwarded to the location manager 1135 via receiver 1110, radio frequency manager 1115, and coexistence manager 1130. The location manager 1135, the antennas 1125a-1125n, receiver 1110, radio frequency manager 1115, and coexistence manager 1130 can be collectively referred to as the GNSS circuitry. The location manager can interpret the signals and determine a location for the mobile device. The location manager can implement the measurement engine, maximum likelihood path selector, estimators and path delays shown in FIG. 5. The location manager can generate correlator outputs and identify peaks in some embodiments.

The location manager 1135 can request location functionality from the coexistence manager 1130. For instance, the location manager 1135 can receive a request for location functionality from one or more scheduled task(s) 1160. In response to the request, the location manager can request information about signals received at the antennas 1125a-1125n from the location manager 1135. In response, the coexistence manager 1130 can request that the radio frequency manager 1115 acquire a connection with a satellite and perform tracking. The request from the coexistence manager 1130 can include an instruction to change the tuning state or tracking mode depending on the current tracking mode.

Power mode manager 1140 can cause the application processor to enter or exit a low power state to conserve power. In a low power state, the power mode manager 1140 may limit the frequency (e.g., clock speed) of one or more of the processing units (e.g., cores) in the application processor 1105. When the application processor 1105 is in a low power state, tasks intended for the application processor 1105 can be stored in a buffer 1145 by the auxiliary processor 1170. When the application processor 1105 leaves the low-power mode, the application processor 1105 can process the queued tasks. The tasks can be queued by the auxiliary processor 1170 which can be a processor that is powered on more frequently than the application processor 1105 (e.g., the application processor 1105 is powered on less frequently than the auxiliary processor).

The power mode manager 1140 can use one or more rules to cause the application processor 1105 to enter or exit the low power state. For example, the power mode manager 1140 can cause the application processor 1105 to enter the low power state based on information received from input component(s) 1150. For example, the input component(s) 1150 can include one or more touchscreens, touchpads, or buttons and the power mode manager 1140 may cause the application processor 1105 to enter a low power state if the input to these devices is below an input threshold. The power mode manager 1140 may monitor the state of battery 1155 and the input threshold may change depending on the current capacity of battery 1155. For example, the input threshold may be higher when the capacity of battery 1155 is below a battery threshold.

In addition, the power mode manager 1140 can monitor scheduled task(s) 1160 from one or more application(s) to determine whether to cause the application processor 1105 to enter the low power state. For example, the power mode manager 1140 may not enter the low power state if a threshold number of tasks(s) 1160 for the application(s) are scheduled for execution on the application processor. The priority of the application(s), or the priority of the scheduled task(s) 1160, may determine whether the power mode manager 1140 causes the application processor 1105 to enter the low power state. In addition, the threshold number of scheduled task(s) 1160 may vary based on the capacity of battery 1155 (e.g., whether the capacity is above or below one or more thresholds). Any combination of the techniques described with reference to the power mode manager 1140 may be used to determine whether to cause the power mode manager 1140 to instruct the application processor 1105 to enter the low power state.

The power mode manager 1140 can cause the application processor 1105 to exit the low power state based on information received from input component(s) 1150. For example, the power mode manager 1140 may cause the application processor 1105 to exit a low power state if the input to these devices is above an input threshold. The power mode manager 1140 may monitor the state of battery 1155 and the input threshold may change depending on the current capacity of battery 1155. For example, the input threshold may be higher when the capacity of battery 1155 is below a battery threshold. The battery threshold for entering the low power state may be higher or lower than the input threshold for leaving the low power state. In addition, the power mode manager 1140 can monitor scheduled task(s) 1160 from one or more application(s) to determine whether to cause the application processor 1105 to exit the low power state. For example, the power mode manager 1140 may exit the low power state if a threshold number of tasks(s) 1160 for the application(s) are scheduled for execution on the application processor. The priority of the application(s), or the priority of the scheduled task(s) 1160, may determine whether the power mode manager 1140 causes the application processor 1105 to exit the low power state. In addition, the threshold number of scheduled task(s) 1160 may vary based on the capacity of battery 1155 (e.g., whether the capacity is above or below one or more thresholds).

The power mode manager 1140 may exit the low power state in response to input from the wireless circuitry 1165. For example, the power mode manager 1140 may cause the application processor 1105 to leave the low power state if information from the wireless circuitry 1165 indicates that the device has connected or disconnected from a wireless access point. In addition, the auxiliary processor 1170 may instruct the power mode manager 1140 to wake the application processor 1105. For example, the auxiliary processor 1170 may provide information about the capacity of buffer 1175 to the power mode manager 1140, and the power mode manager 1140 may wake the application processor 1105 if the capacity of buffer 1175 is above a threshold. In some embodiments, the power mode manager 1140 may wake (e.g., cause the application processor to exit the low power state) at regular intervals. Any combination of the techniques described with reference to the power mode manager 1140 may be used to determine whether to cause the power mode manager 1140 to instruct the application processor 1105 to exit the low power state.

The wireless circuitry 1165 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1165 can use various protocols, e.g., as described herein. In various embodiments, wireless circuitry 1165 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

### V. Flow

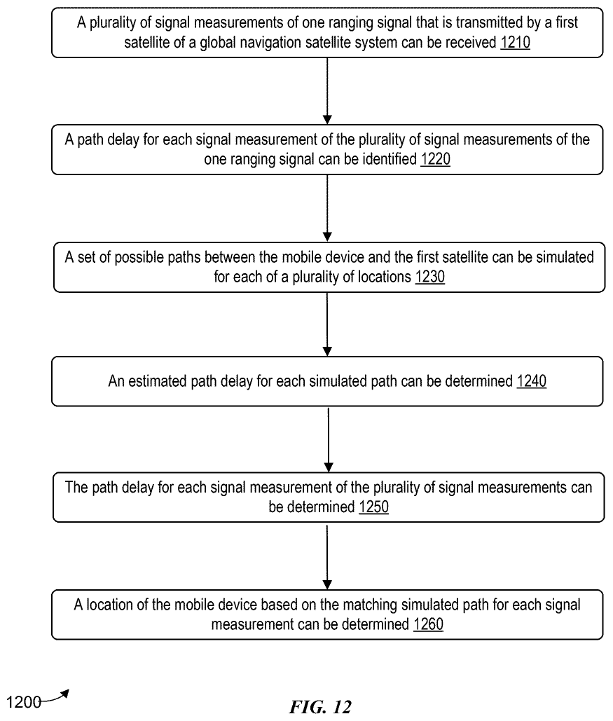

FIG. 12 is a flowchart illustrating a method 1200 for ray tracing to determine a mobile device's location according to various embodiments. In some implementations, one or more method blocks of FIG. 12 may be performed by a mobile device (e.g., user equipment 11, architecture 1100, electronic device 1300). In some implementations, one or more method blocks of FIG. 12 may be performed by another device or a group of devices separate from or including the mobile device. Additionally, or alternatively, one or more method blocks of FIG. 12 may be performed by one or more components of the mobile device, such as processor 22, memory 24, nonvolatile storage 26, input structures 30, network interface 34, sensors 37, GNSS receiver 118, antenna 50, measurement engine 604, simulation engine 606, path selection engine 608, estimator 610, application processor 1105, receiver 1110, antenna 1125a-1125n, location manager 1135, input components 1150, wireless circuitry 1165, auxiliary processor 1170, inertial sensor(s) 1180, processor 1318, computer-readable medium 1302, Input/Output (I/O) subsystem 1306, wireless circuitry 1308, etc.

As shown in FIG. 12, method 1200 may include, at block 1210, a plurality of signal measurements of one ranging signal that is transmitted by a first satellite of a global navigation satellite system can be received. The signal measurements can be received from memory or the signal measurements can be received at a global navigation satellite system (GNSS) receiver (e.g., a channel). The one ranging signal can be measured by one or more antennas of the mobile device. Each measurement of the one or more of the measurements can correspond to a different path of the one ranging signal to the one or more antennas of the mobile device. The measurement can be a pseudorange between the first satellite and an antenna of the mobile device. Signal paths are described in section II with reference to FIGS. 4A-6.

Receiving the plurality of signal measurements can include allocating a plurality of channels to the first satellite. A channel can be a global navigation satellite system (GNSS) receiver, and channels can be allocated to the first satellite until a threshold number of signal measurements are received. At least two channels can be allocated to the first satellite, but any number of channels can be allocated to any number of satellites. The measurement from each allocated channel can correspond to a possible path of the set of possible paths. Each channel can be used to identify matching signals using an ambiguity function. For example, each allocated channel can measure a plurality of samples of the one ranging signal using the antennas of the mobile device. Correlation signals can be generated for each allocated channel, and each correlation signal can be a locally generated version of the ranging signal. Either, or both, of the phase and frequency can be varied between each correlation signal. The correlation signals can be compared to the plurality of samples of the one signal, and the comparisons can be used to determine a correlation magnitude for each signal. A sample with the highest correlation magnitude can be identified as a signal measurement, and the channel can be deallocated after identifying the measurement. Channels and signal measurements are described in section III with reference to FIGS. 7-10.

Multiple signal measurements may be measured using a single channel. A channel may be allocated to the first satellite until a threshold number of signal measurements are received. The channel can be used to perform coherent signal integration operations (e.g., generate the output of one or more ambiguity functions). For example, the channel can be used to measure a plurality of samples of the one signal using one or more antennas of the mobile device. The channel can generate a plurality of correlation signals, and each correlation signal can be a locally generated version of the one signal. The phase, the frequency, or both the phase and frequency can be varied for each correlation signal. The difference in frequency between two signals can be a frequency offset, and the difference in phase between two signals can be a phase offset. The plurality of samples of the one signal can be compared to the plurality of correlation signals to determine a plurality of correlation magnitudes. One or more samples of the plurality of samples can be identified as signal measurements, and, for example, a sample may be identified as a signal measurement if the correlation magnitude for the sample is a local maxima.

At block 1220, a path delay for each signal measurement of the one ranging signal can be identified. In some embodiments, each signal measurement can be a pseudorange and the path delay can be determined from the pseudorange. For example, the pseudorange can include the signal time-of-flight and covariance matrices. The covariance matrices can include delays caused by clock biases (e.g., synchronization errors between the satellite clock and the mobile device clock), atmospheric delays (e.g., delays caused by the ionosphere or the troposphere), and measurement noise. The signal time-of-flight can be identified by estimating, and removing, the covariance matrices from the pseudorange. In some embodiments, the signal time-of-flight (e.g., the time between signal transmission by the first satellite and signal reception by the mobile device) can be the path delay.

In some embodiments, the path delay can be identified from the signal time-of-flight. For example, the path delay can be a multipath delay caused by a non-line-of-sight path between the first satellite and an antenna of the mobile device. The path delay can be determined by subtracting an estimated time-of-flight along a line-of-sight path from the signal's measured time-of-flight. The path delay can be the extra time-of-flight that is caused by a non-line-of-sight signal path (e.g., a time delay).

At block 1230, a set of possible paths between the mobile device and the first satellite can be simulated for each of a plurality of locations. The set of possible paths include at least one path that reflects from a building in a map model (e.g., a building model) around a previously measured location of the mobile device, thereby determining a plurality of sets of simulated paths. In some embodiments, the map model can include geographic features (e.g., hills, valleys, and mountains) and the possible paths may include at least one path that reflects from a geographic feature. In some embodiments, the path delays may be simulated after determining that the mobile device is in a particular signal environment. The particular signal environment may be an environment in which the signal is likely to reflect from a building or a geographic feature. The particular signal environment may be a dense urban environment in some embodiments. Simulating signal paths are described in section II with reference to FIGS. 4A-6.

At block 1240, an estimated path delay for each simulated path can be determined. The estimated path delay can be estimated by taking a difference between a the time-of-flight for a non-line-of-sight simulated path and the time-of-flight for a line-of-sight simulated path. The difference in time can be the estimated path delay. In some embodiments, the estimated path delay can be a difference between a time-of-flight for a simulated path that was generated using the map model, and a time-of-flight for a simulated path that was not generated using the map model. A time-of-flight can be determined from a path by multiplying the length of the path by the signal's propagation speed (e.g., c in a vacuum). Path delays can be estimated using the techniques described in sections II and III with reference to FIGS. 4A-10.

At block 1250, the path delay for each signal measurement of the plurality of signal measurements can be compared to each estimated path delay to identify at least one matching simulated path for each signal measurement. The path delay and estimated path delay can be compared using a probability density function, and the matching simulated path can be the path with the highest probability among all the estimated path delays. A simulated path can be a matching path for a signal measurement if the path delay of the signal measurement is within a threshold time difference of the estimated path delay. The time threshold can be 1 microsecond, (μs), 2 μs, 3 μs, 4 μs, 5 μs, 10 μs, 15 μs, 20 μs, 25 μs. 50 μs, 100 μs, 1 millisecond (ms), 5 ms, 10 ms, 50 ms, 100 ms, 500 ms, and 1 second. Comparing the path delays are described in Sections II and III with reference to FIGS. 4A-10.

At block 1260, a location of the mobile device based on the matching simulated path for each signal measurement can be determined. Each location can have an aggregate probability that is based on the probability of three or more matching simulated paths that correspond to the location. The location of the mobile device can be a location with the highest aggregate probability within the search space. The location of the mobile device can be determined using the techniques described in Section II.C and III.A with reference to FIGS. 6-7.

Method 1200 may include additional implementations, such as any single implementation or any combination of implementations described below and/or in connection with one or more other processes described elsewhere herein.

Although FIG. 12 shows example blocks of method 1200, in some implementations, method 1200 may include additional blocks, fewer blocks, different blocks, or differently arranged blocks than those depicted in FIG. 12. Additionally, or alternatively, two or more of the blocks of method 1200 may be performed in parallel.

### VI. Example Device

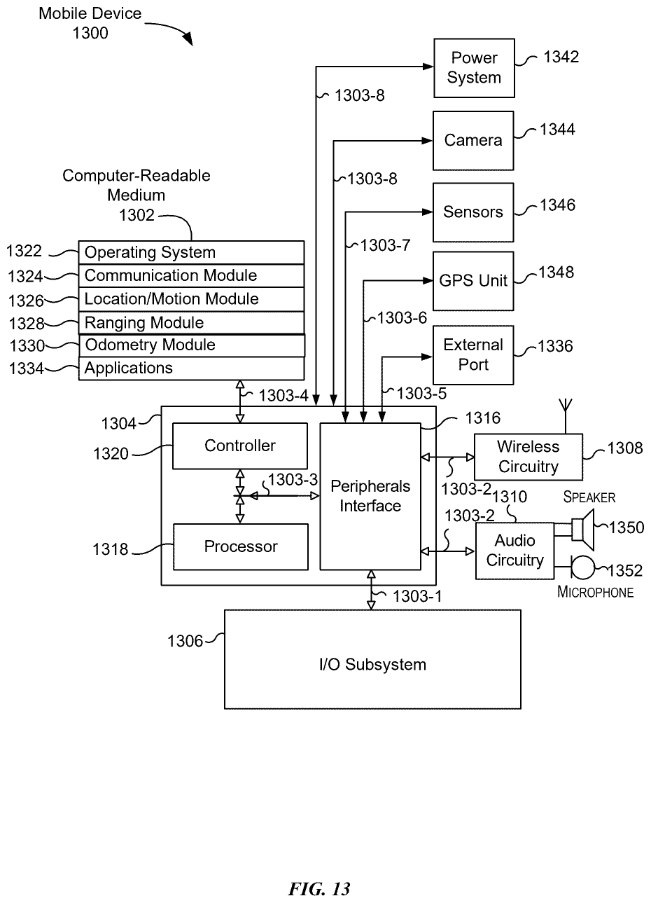

FIG. 13 is a block diagram of an example electronic device 1300 according to various embodiments. Device 1300 generally includes computer-readable medium 1302, a processing system 1304, an Input/Output (I/O) subsystem 1306, wireless circuitry 1308, and audio circuitry 1310 including speaker 1312 and microphone 1314. These components may be coupled by one or more communication buses or signal lines 1303. Device 1300 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

It should be apparent that the architecture shown in FIG. 13 is only one example of an architecture for device 1300, and that device 1300 can have more or fewer components than shown, or a different configuration of components. The various components shown in FIG. 13 can be implemented in hardware, software, or a combination of both hardware and software, including one or more signal processing and/or application specific integrated circuits.

Wireless circuitry 1308 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1308 can use various protocols, e.g., as described herein. In various embodiments, wireless circuitry 1308 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1308 is coupled to processing system 1304 via peripherals interface 1316. Peripherals interface 1316 can include conventional components for establishing and maintaining communication between peripherals and processing system 1304. Voice and data information received by wireless circuitry 1308 (e.g., in speech recognition or voice command applications) is sent to one or more processors 1318 via peripherals interface 1316. One or more processors 1318 are configurable to process various data formats for one or more application programs 1334 stored on medium 1302.

Peripherals interface 1316 couple the input and output peripherals of device 1300 to the one or more processors 1318 and computer-readable medium 1302. One or more processors 1318 communicate with computer-readable medium 1302 via a controller 1320. Computer-readable medium 1302 can be any device or medium that can store code and/or data for use by one or more processors 1318. Computer-readable medium 1302 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1316, one or more processors 1318, and controller 1320 can be implemented on a single chip, such as processing system 1304. In some other embodiments, they can be implemented on separate chips.

Processor(s) 1318 can include hardware and/or software elements that perform one or more processing functions, such as mathematical operations, logical operations, data manipulation operations, data transfer operations, controlling the reception of user input, controlling output of information to users, or the like. Processor(s) 1318 can be embodied as one or more hardware processors, microprocessors, microcontrollers, field programmable gate arrays (FPGAs), application-specified integrated circuits (ASICs), or the like.

Device 1300 also includes a power system 1342 for powering the various hardware components. Power system 1342 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1300 includes a camera 1344. In some embodiments, device 1300 includes sensors 1346. Sensors can include accelerometers, compass, gyrometer, pressure sensors, audio sensors, light sensors, barometers, and the like. Sensors 1346 can be used to sense location aspects, such as auditory or light signatures of a location.

In some embodiments, device 1300 can include a GPS receiver, sometimes referred to as a GPS unit 1348. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1318 run various software components stored in medium 1302 to perform various functions for device 1300. In some embodiments, the software components include an operating system 1322, a communication module 1324 (or set of instructions), a location module 1326 (or set of instructions), a ranging module 1328 that is used as part of ranging operation described herein, and other application programs 1334 (or set of instructions).

Operating system 1322 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1324 facilitates communication with other devices over one or more external ports 1336 or via wireless circuitry 1308 and includes various software components for handling data received from wireless circuitry 1308 and/or external port 1336. External port 1336 (e.g., universal serial bus (USB), FireWire, Lightning connector, 70-pin connector, etc.) is adapted for coupling directly to other devices or indirectly over a network (e.g., the Internet, wireless local area network (LAN), etc.).

Location/motion module 1326 can assist in determining the current position (e.g., coordinates or other geographic location identifiers) and motion of device 1300. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1326 receives data from GPS unit 1348 and analyzes the signals to determine the current position of the mobile device. In some embodiments, location/motion module 1326 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1308 and is passed to location/motion module 1326. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1300 based on the position coordinates of the corresponding transmitters. Regardless of the specific location technology used, location/motion module 1326 receives information from which a location fix can be derived, interprets that information, and returns location information, such as geographic coordinates, latitude/longitude, or other location fix data

Ranging module 1328 can send/receive ranging messages to/from an antenna, e.g., connected to wireless circuitry 1308. The messages can be used for various purposes, e.g., to identify a sending antenna of a device, determine timestamps of messages to determine a distance of electronic device 1300 from another device. Ranging module 1328 can exist on various processors of the device, e.g., an always-on processor (AOP), a UWB chip, and/or an application processor. For example, parts of ranging module 1328 can determine a distance on an AOP, and another part of the ranging module can interact with a sharing module, e.g., to display a position of the other device on a screen in order for a user to select the other device to share a data item. Ranging module 1328 can also interact with a reminder module that can provide an alert based on a distance from another mobile device.

Odometry module 1330 can perform odometry techniques to determine the location and orientation of electronic device 1300 within a physical environment. Output from the camera 1344 and the sensors 1346 can be accessed by the odometry module 1330, and the odometry module 1330 can use this information to perform visual inertial odometry techniques. The odometry module 1330 can identify and compare features in sequential images captured by camera 1344 to determine the camera's movement relative to those features. The odometry module 1330 may use information from the sequential images to create a map of the environment. In addition or alternatively, inertial information from sensors 1346 can be used to estimate the movement of the electronic device 1300. Inertial information can include any combination of linear acceleration, angular acceleration, linear velocity, angular velocity, and magnetometer readings, and the inertial information can be in any number of axes.

The one or more applications 1334 on device 1300 can include any applications installed on the device 1300, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1306 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1306 can include a display and user input devices such as a keyboard, mouse, and/or trackpad. In some embodiments, I/O subsystem 1306 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1302) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1306 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1300 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other $2 regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method performed by a processor of a mobile device, comprising:
receiving a plurality of signal measurements of one ranging signal that is transmitted by a first satellite of a global navigation satellite system, wherein the one ranging signal is measured by one or more antennas of the mobile device, each measurement corresponding to a different path of the one ranging signal to the one or more antennas of the mobile device;
identifying a path delay for each signal measurement of the plurality of signal measurements of the one ranging signal;
simulating, for each of a plurality of locations, a set of possible paths between the mobile device and the first satellite, wherein the set of possible paths include at least one path that reflects from a building in a map model around a previously measured location of the mobile device, thereby determining a plurality of sets of simulated paths;
determining an estimated path delay for each simulated path;
comparing the path delay for each signal measurement of the plurality of signal measurements to each estimated path delay to identify at least one matching simulated path for each signal measurement; and
determining a location of the mobile device based on the at least one matching simulated path for each signal measurement.

2. The method of claim 1, wherein receiving the plurality of signal measurements comprises until a threshold number of signal measurements are received:
allocating a plurality of channels to the first satellite, wherein each allocated channel corresponds to a possible path of the set of possible paths;
for at least two allocated channels:
measuring a plurality of samples of the one ranging signal by the one or more antennas of the mobile device;
generating a plurality of correlation signals, wherein each correlation signal of the plurality of correlation signals is a locally generated version of the one ranging signal at a frequency and a phase offset, wherein one or more of the frequency and the phase offset varies between each correlation signal;
determining a correlation magnitude between each of the plurality of samples and the plurality of correlation signals, thereby determining a plurality of correlation magnitudes;
identifying a sample that corresponds to a maximum correlation magnitude as a signal measurement; and
deallocating the allocated channel.

3. The method of claim 2, wherein a channel comprises a global navigation satellite system (GNSS) receiver.

4. The method of claim 1, wherein receiving the plurality of signal measurements comprises until a threshold number of signal measurements are received:
allocating a channel to the first satellite:
measuring a plurality of samples by the one or more antennas of the mobile device;
generating a plurality of correlation signals, wherein each correlation signal of the plurality of correlation signals is a locally generated version of the one ranging signal at a frequency and a phase offset, wherein one or more of the frequency and the phase offset varies between each correlation signal;
determining a correlation magnitude between each of the plurality of samples and the plurality of correlation signals, thereby determining a plurality of correlation magnitudes; and
identifying one or more samples of the plurality of samples as signal measurements of the plurality of signal measurements, wherein correlation magnitudes of each of the one or more samples are local maxima.

5. The method of claim 1, wherein identifying the path delay of a signal measurement comprises:
determining a first time-of-flight of the one ranging signal along a path corresponding to the signal measurement;
determining a second time-of-flight of the one ranging signal along a line-of-sight path; and
determining the path delay, wherein the path delay is a time difference between the first time of flight and the second time of flight.

6. The method of claim 1, wherein a simulated path is the at least one matching simulated path for a signal measurement if the path delay of the signal measurement and the estimated path delay of the simulated path are within a threshold time difference.

7. The method of claim 1, wherein the set of possible paths are simulated after:
determining that the mobile device is in a particular signal environment.

8. A mobile device, comprising:
one or more processors;
a memory coupled to the one or more processors, the memory storing instructions that cause the one or more processors to perform any one or more of operations to:
receive a plurality of signal measurements of one ranging signal that is transmitted by a first satellite of a global navigation satellite system, wherein the one ranging signal is measured by one or more antennas of the mobile device, each measurement corresponding to a different path of the one ranging signal to the one or more antennas of the mobile device;
identify a path delay for each signal measurement of the plurality of signal measurements of the one ranging signal;
simulate, for each of a plurality of locations, a set of possible paths between the mobile device and the first satellite, wherein the set of possible paths include at least one path that reflects from a building in a map model around a previously measured location of the mobile device, thereby determining a plurality of sets of simulated paths;
determine an estimated path delay for each simulated path;
compare the path delay for each signal measurement of the plurality of signal measurements to each estimated path delay to identify at least one matching simulated path for each signal measurement; and
determine a location of the mobile device based on the at least one matching simulated path for each signal measurement.

9. The mobile device of claim 8, wherein receiving the plurality of signal measurements comprises, until a threshold number of signal measurements are received, performing operations to:
allocate a plurality of channels to the first satellite, wherein each allocated channel corresponds to a possible path of the set of possible paths;
for at least two allocated channels:
measure a plurality of samples of the one ranging signal by the one or more antennas of the mobile device;
generate a plurality of correlation signals, wherein each correlation signal of the plurality of correlation signals is a locally generated version of the one ranging signal at a frequency and a phase offset, wherein one or more of the frequency and the phase offset varies between each correlation signal;
determine a correlation magnitude between each of the plurality of samples and the plurality of correlation signals, thereby determining a plurality of correlation magnitudes;
identify a sample that corresponds to a maximum correlation magnitude as a signal measurement; and
deallocate the allocated channel.

10. The mobile device of any of claim 9, wherein a channel comprises a global navigation satellite system (GNSS) receiver.

11. The mobile device of claim 8, wherein receiving the plurality of signal measurements comprises, until a threshold number of signal measurements are received, performing operations to:
allocate a channel to the first satellite:
measure a plurality of samples by the one or more antennas of the mobile device;
generate a plurality of correlation signals, wherein each correlation signal of the plurality of correlation signals is a locally generated version of the one ranging signal at a frequency and a phase offset, wherein one or more of the frequency and the phase offset varies between each correlation signal;
determine a correlation magnitude between each of the plurality of samples and the plurality of correlation signals, thereby determining a plurality of correlation magnitudes; and
identify one or more samples of the plurality of samples as signal measurements of the plurality of signal measurements, wherein correlation magnitudes of each of the one or more samples are local maxima.

12. The mobile device of claim 8, wherein identifying the path delay of a signal measurement comprises operations to:
determine a first time-of-flight of the one ranging signal along a path corresponding to the signal measurement;
determine a second time-of-flight of the one ranging signal along a line-of-sight path; and
determine the path delay, wherein the path delay is a time difference between the first time of flight and the second time of flight.

13. The mobile device of claim 8, wherein a simulated path is the at least one matching simulated path for a signal measurement if the path delay of the signal measurement and the estimated path delay of the simulated path are within a threshold time difference.

14. The mobile device of claim 1, wherein the set of possible paths are simulated after operations to:
determine that the mobile device is in a particular signal environment.

15. A non-transitory, computer readable medium, the non-transitory computer readable medium storing instructions that when executed on one or more processors perform operations to:
receive a plurality of signal measurements of one ranging signal that is transmitted by a first satellite of a global navigation satellite system, wherein the one ranging signal is measured by one or more antennas of a mobile device, each measurement corresponding to a different path of the one ranging signal to the one or more antennas of the mobile device;
identify a path delay for each signal measurement of the plurality of signal measurements of the one ranging signal;
simulate, for each of a plurality of locations, a set of possible paths between the mobile device and the first satellite, wherein the set of possible paths include at least one path that reflects from a building in a map model around a previously measured location of the mobile device, thereby determining a plurality of sets of simulated paths;
determine an estimated path delay for each simulated path;
compare the path delay for each signal measurement of the plurality of signal measurements to each estimated path delay to identify at least one matching simulated path for each signal measurement; and
determine a location of the mobile device based on the at least one matching simulated path for each signal measurement.

16. The non-transitory, computer readable medium of claim 15, wherein receiving the plurality of signal measurements comprises, until a threshold number of signal measurements are received, performing operations to:
allocate a plurality of channels to the first satellite, wherein each allocated channel corresponds to a possible path of the set of possible paths;
for at least two allocated channels:
measure a plurality of samples of the one ranging signal by the one or more antennas of the mobile device;
generate a plurality of correlation signals, wherein each correlation signal of the plurality of correlation signals is a locally generated version of the one ranging signal at a frequency and a phase offset, wherein one or more of the frequency and the phase offset varies between each correlation signal;
determine a correlation magnitude between each of the plurality of samples and the plurality of correlation signals, thereby determining a plurality of correlation magnitudes;
identify a sample that corresponds to a maximum correlation magnitude as a signal measurement; and
deallocate the allocated channel.

17. The non-transitory, computer readable medium of any of claim 16, wherein a channel comprises a global navigation satellite system (GNSS) receiver.

18. The non-transitory, computer readable medium of claim 15, wherein receiving the plurality of signal measurements comprises, until a threshold number of signal measurements are received, performing operations to:
allocate a channel to the first satellite:
measure a plurality of samples by the one or more antennas of a mobile device;
generate a plurality of correlation signals, wherein each correlation signal of the plurality of correlation signals is a locally generated version of the one ranging signal at a frequency and a phase offset, wherein one or more of the frequency and the phase offset varies between each correlation signal;
determine a correlation magnitude between each of the plurality of samples and the plurality of correlation signals, thereby determining a plurality of correlation magnitudes; and
identify one or more samples of the plurality of samples as signal measurements of the plurality of signal measurements, wherein correlation magnitudes of each of the one or more samples are local maxima.

19. The non-transitory, computer readable medium of claim 15, wherein identifying the path delay of a signal measurement comprises operations to:
determine a first time-of-flight of the one ranging signal along a path corresponding to the signal measurement;
determine a second time-of-flight of the one ranging signal along a line-of-sight path; and
determine the path delay, wherein the path delay is a time difference between the first time of flight and the second time of flight.

20. The non-transitory, computer readable medium of claim 15, wherein a simulated path is the at least one matching simulated path for a signal measurement if the path delay of the signal measurement and the estimated path delay of the simulated path are within a threshold time difference.
